(19) United States
(12) Patent Application Publication
(10) Pub. No.: US 2014/0378156 A1
(43) Pub. Date: Dec. 25, 2014

(54) DISTRIBUTED ANTENNA SYSTEM, MANAGEMENT CONTROL DEVICE, CONTROL METHOD OF MANAGEMENT CONTROL DEVICE, AND COMPUTER PROGRAM PRODUCT

(71) Applicant: Kabushiki Kaisha Toshiba, Tokyo (JP)

(72) Inventors: Kenichi Ohno, Zama-shi (JP); Taichi Tashiro, Fuchu-shi (JP)

(73) Assignee: Kabushiki Kaisha Toshiba, Tokyo (JP)

(21) Appl. No.: 14/163,111

(22) Filed: Jan. 24, 2014

(30) Foreign Application Priority Data
Jun. 24, 2013 (JP) 2013-132038

(51) Int. Cl. H04W 72/08

(52) U.S. Cl. CPC H04W 72/082
USPC 455/452.2

(57) ABSTRACT

According to one embodiment, a distributed antenna system includes a plurality of antennas, a plurality of base stations, an antenna control device, and a management control device. The base stations wirelessly communicate with a wireless communication terminal. The base stations are assigned with a plurality of different operating frequencies, respectively. The antenna control device is connected to the antennas and is capable of connecting at least one of the antennas to any one of the base stations. The management control device causes the one of the base stations to measure reception power at the at least one of the antennas at an operating frequency corresponding to other base station which is not managed by the management control device, and assigns an operating frequency having a less inter-cell interference caused by the other base station to the at least one of the antennas based on the measured reception power.

### CROSS-REFERENCE TO RELATED APPLICATIONS

This application is based upon and claims the benefit of priority from Japanese Patent Application No. 2013-132038, filed on Jun. 24, 2013, the entire contents of which are incorporated herein by reference.

### FIELD

Embodiments described herein relate generally to a distributed antenna system, a management control device, a control method of the management control device, and a recording medium.

### BACKGROUND

In recent years, mobile data traffic has steeply increased as smartphones and tablet-type terminals come into wide use. In particular, population of users is dense in indoor areas in many cases. For this reason, relatively small cells called femto cells or pico cells are effectively used for the indoor areas to cover the radio capacity for handling the traffic.

However, in order to handle the traffic of the indoor areas by a configuration in which an antenna is branched from a base station by using a plurality of antennas, the base station and the antennas are connected in a fixed manner. Therefore, for example, it is difficult to reduce an inter-cell interference caused by another base station which is a non-target base station (not under the management) provided in an outdoor area.

Specifically, if the antennas and the base station are connected in the fixed manner, when the operating frequency of another outdoor base station in the same operating frequency band is the same as that of the base station, it is difficult to avoid the inter-cell interference.

### BRIEF DESCRIPTION OF THE DRAWING

FIG. 1 is a diagram schematically illustrating a configuration of a distributed antenna system according to a first embodiment;

FIG. 2 is a diagram schematically illustrating a configuration of each unit of the distributed antenna system according to the first embodiment;

FIG. 3 is a diagram illustrating the data format of base station antenna information that is stored in a base station antenna information unit according to the first embodiment;

FIG. 4 is a diagram illustrating the data format of operating frequency information that is stored in an operating frequency information unit according to the first embodiment;

FIG. 5 is a diagram illustrating the data format of radio wave information that is stored in a radio wave information unit according to the first embodiment;

FIG. 6 is a diagram illustrating operations according to the first embodiment;

FIG. 7 is a diagram illustrating a state after an antenna switching operation, according to the first embodiment; and

FIG. 8 is a flowchart illustrating a process in a radio wave information measuring mode according to a second embodiment.

### DETAILED DESCRIPTION

In general, according to one embodiment, a distributed antenna system includes a plurality of antennas, a plurality of base stations, an antenna control device, and a management control device. The base stations wirelessly communicate with a wireless communication terminal. The base stations are assigned with a plurality of different operating frequencies, respectively. The antenna control device is connected to the antennas and is capable of connecting at least one of the antennas to any one of the base stations. The management control device that causes the one of the base stations to measure reception power at the at least one of the antennas at an operating frequency corresponding to other base station which is not managed by the management control device, and assigns an operating frequency having a less inter-cell interference caused by the other base station to the at least one of the antennas based on the measured reception power.

Next, embodiments will be described with reference to the drawings.

### First Embodiment

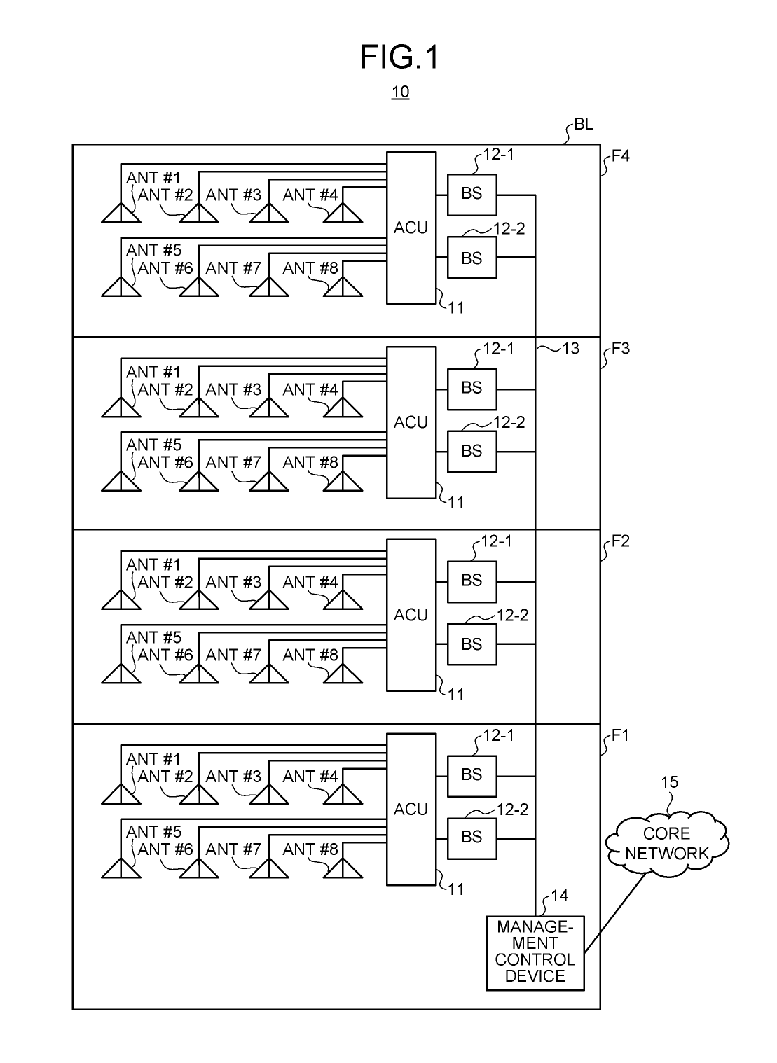

FIG. 1 is a diagram schematically illustrating a configuration of a distributed antenna system according to a first embodiment.

In FIG. 1, a building BL has four floors F1 to F4, as an example. Further, eight antennas ANT #1 to ANT #8 and two base stations (BS) are disposed in each floor, as an example.

A distributed antenna system 10 is provided with the eight antennas ANT #1 to ANT #8 which are disposed in each of the floors F1 to F4.

Each of the antennas ANT #1 to ANT #8 is connected to any one of a base station (BS) 12-1 and a base station 12-2, via an antenna control device (ACU) 11.

The base station 12-1 and the base station 12-2 are connected to a management control device 14, which manages and controls the entire distributed antenna system 10, via a local network (LAN) 13.

In addition, the management control device 14 is connected to an external core network 15 via the local network 13.

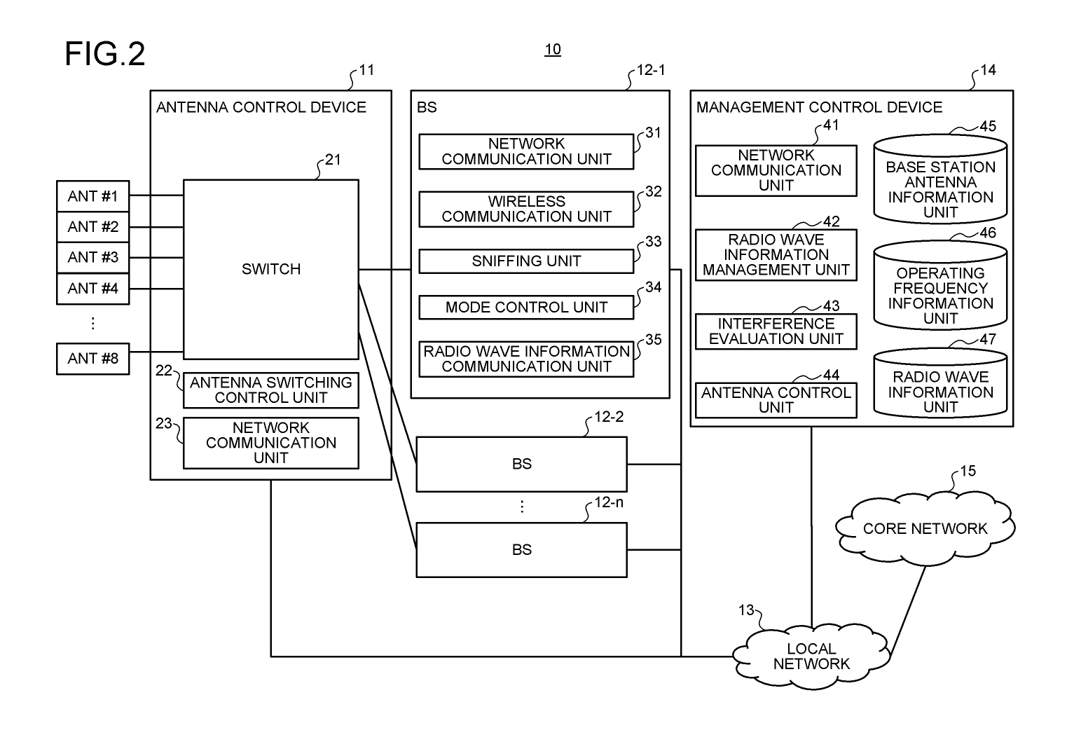

FIG. 2 is a diagram schematically illustrating a configuration of each unit of the distributed antenna system.

Herein, FIG. 2 illustrates an example in which the number of base stations is n, and FIG. 1 illustrates an example of n=2.

The antenna control device 11 is provided with: a switch 21 that switches the base stations to be connected to the eight antennas ANT #1 to ANT #8; an antenna switching control unit 22 that performs switching control of the switch 21; and a network communication unit 23 that performs control to communicate with the outside via a wired communication network.

Each of the base stations 12-1 to 12-n is provided with: a network communication unit 31 which performs control to communicate with the outside via the wired communication network; and a wireless communication unit 32 which processes a protocol for the communication with a wireless terminal device.

Further, the base stations 12-1 to 12-n serve as analyzers, and receive a downlink (DL: Down Link) signal which is sent from an outdoor base station (another base station) to the wireless terminal device. Each of the base stations is provided with: a sniffing unit 33 which has a function of measuring radio wave information related to a radio wave state (=operating frequency, reception power [radio field intensity], and the like) of the outdoor base station; and a mode control unit 34 which controls a switching operation between a normal operation mode and a radio wave information measuring operation mode.

In addition, each of the base stations 12-1 to 12-n is provided with a radio wave information communication unit 35 which sends the radio wave information measured by the sniffing unit 33 to the management control device 14 via the local network 13.

The management control device 14 is provided with: a network communication unit 41 which performs control to communicate with the outside via the wired communication network; and a radio wave information management unit 42 which gives a command for measuring the radio wave information and receives and manages the radio wave information sent from the radio wave information communication units 35 of the respective base stations 12-1 to 12-n via the local network 13.

Further, the management control device 14 is provided with an interference evaluation unit 43. The interference evaluation unit 43 evaluates an inter-cell interference caused by an outdoor base station, using base station antenna information and operating frequency information to be described below together with the radio wave information. Here, the outdoor base station is a non-target base station (not under the management) of the distributed antenna system 10, and is disposed outside the building BL. Then, the interference evaluation unit 43 determines the assignment of the respective antennas ANT #1 to ANT #8 to the base stations 12-1 to 12-n.

In addition, the management control device 14 is provided with an antenna control unit 44 and a base station antenna information unit 45. The antenna control unit 44 informs the antenna control device 11 of the assignment of the antennas ANT #1 to ANT #8 to the base stations 12-1 to 12-n determined by the interference evaluation unit 43 via the local network 13. The base station antenna information unit 45 stores therein antenna IDs used for specifying antennas actually connected to the respective base stations 12-1 to 12-n.

In addition, the management control device 14 is provided with: an operating frequency information unit 46 which stores therein operating frequencies set in the respective base stations 12-1 to 12-n; and a radio wave information unit 47 which stores therein information on the reception power of the downlink (DL) signal sent from the outdoor base station for each antenna.

Herein, before describing the embodiment, the data formats of the information stored in the base station antenna information unit 45, the operating frequency information unit 46, and the radio wave information unit 47 will be described.

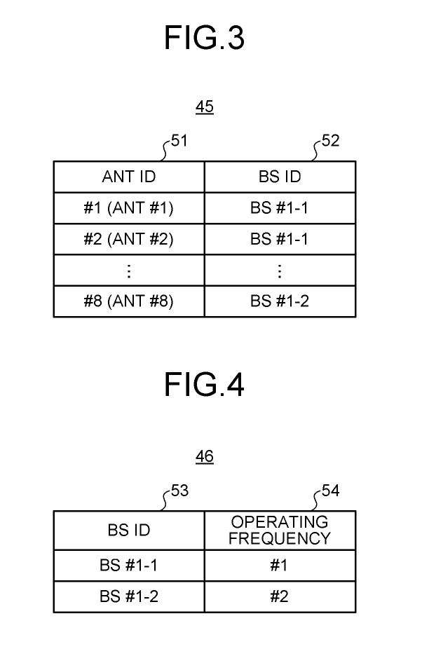

FIG. 3 is a diagram illustrating the data format of base station antenna information that is stored in the base station antenna information unit 45.

The base station antenna information unit 45 stores therein, as the base station antenna information, antenna ID data 51 for specifying an antenna and base station ID data 52 for specifying a base station in association with each other.

For example, if the antenna ID data 51 is antenna ID=“#2” specifying the antenna ANT #2, it can be known that the base station ID data 52 corresponding to such antenna ID is base station ID=“BS #1-1” corresponding to the base station 12-1.

Therefore, by referring to the base station antenna information unit 45, it can be known that the antenna ANT #2 is currently connected to the base station 12-1.

FIG. 4 is a diagram illustrating the data format of operating frequency information that is stored in the operating frequency information unit.

The operating frequency information unit 46 stores therein, as the operating frequency information, base station ID (BSID) data 53 for specifying a base station and operating frequency data 54 for specifying an operating frequency in association with each other.

For example, the operating frequency data 54 corresponding to base station ID=“BS #1-1” specifying the base station 12-1 is set to operating frequency ID=“#1” corresponding to a first operating frequency band. Further, the operating frequency data 54 corresponding to base station ID=“BS #1-2” specifying the base station 12-2 is set to operating frequency ID=“#2” corresponding to a second operating frequency band.

Therefore, by referring to the operating frequency information unit 46, the operating frequencies of the respective base stations 12-1 to 12-n can be known.

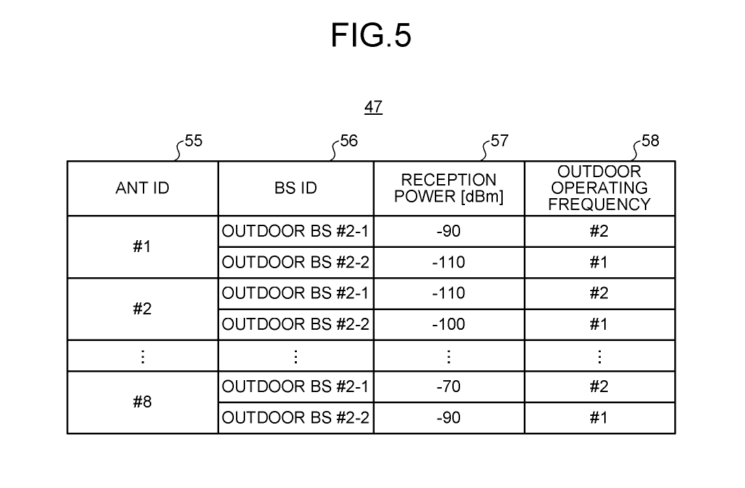

FIG. 5 is a diagram illustrating the data format of radio wave information that is stored in a radio wave information unit 47

The radio wave information unit 47 stores therein, as the radio wave information, antenna ID data 55, base station ID data 56, reception power data 57, and outdoor operating frequency data 58, in association with each other.

Herein, the antenna ID data 55 stores antenna IDs for specifying an antenna through which a radio wave is received.

The base station ID data 56 stores therein base station IDs for specifying an outdoor base station from which the radio wave is sent through the antenna corresponding to the antenna ID data 55.

The reception power data 57 stores therein reception power of when a downlink signal of the outdoor base station specified in the base station ID data 56 is received through the antenna specified in the antenna ID data 55.

The outdoor operating frequency data 58 stores therein an operating frequency of the outdoor base station specified in the base station ID data 56.

For example, by referring to the antenna ID data 55 and the base station ID data 56, it can be known that the reception power measured when the downlink signal is received through the antenna ANT #2 (antenna ID=“#2”) from the outdoor base station corresponding to the base station ID data 56=“outdoor BS #2-1” is “−110 dBm” from the reception power data 57. Further, it can be known that the operating frequency is operating frequency ID=“#2” corresponding to the second operating frequency band from the outdoor operating frequency data 58.

Therefore, by referring to the radio wave information unit 47, it can be easily grasped whether the inter-cell interference caused by the outdoor base station occurs.

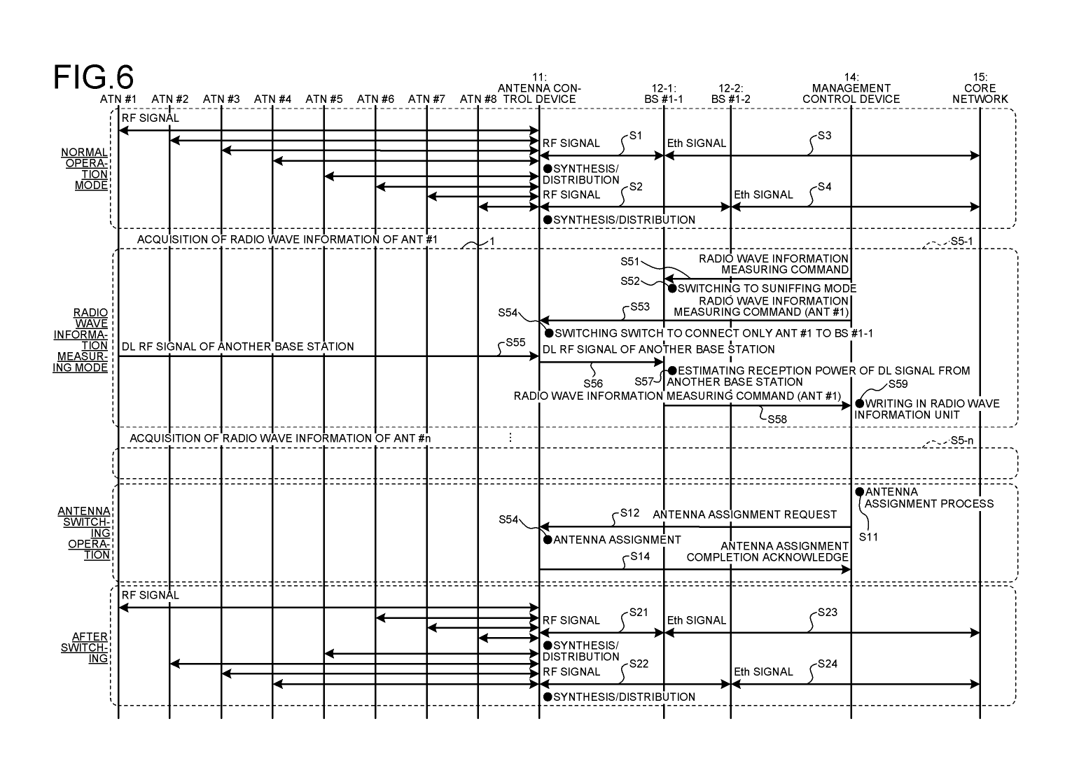

FIG. 6 is a diagram illustrating operations of the first embodiment.

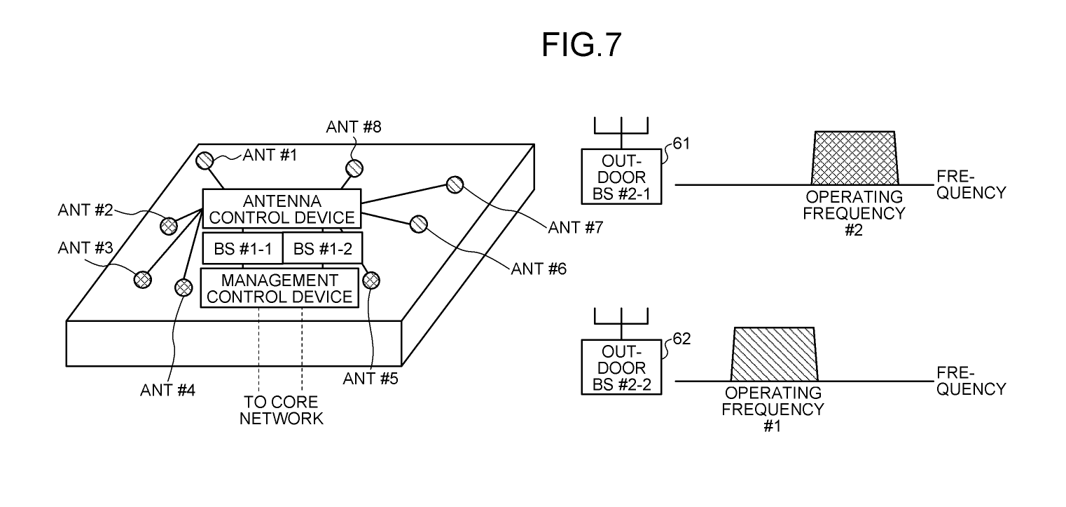

FIG. 7 is a diagram illustrating a state after an antenna switching operation in the first embodiment.

In the following, the description will be made for the case when a mode is changed from a normal operation mode (a normal time) to a radio wave information measuring mode (a radio wave information measuring time), and the antenna switching operation (an antenna reception frequency assignment) is performed on the basis of the measurement of the radio wave information.

The antennas ANT #1 to ANT #4 are connected to the base station 12-1 in an initial state. Further, the operating frequencies of the antennas ANT #1 to ANT #4 in the initial state are set to the first operating frequency band (operating frequency ID=“#1”).

Further, the antennas ANT #5 to ANT #8 are connected to the base station 12-2 in the initial state. Further, the operating frequencies of the antennas ANT #5 to ANT #8 in the initial state are set to the second operating frequency band (operating frequency ID=“#2”).

### Normal Operation Mode

As illustrated in FIG. 6, in the normal time (the normal operation mode), when uplink signals (operating frequency ID=“#1”) are sent from the wireless terminal devices through the antennas ANT #1 to ANT #4 based on a predetermined antenna assignment, the antenna control device 11 synthesizes radio frequency (RF) signals input through the antennas ANT #1 to ANT #4, and transmits the synthesized signal to the base station 12-1. Further, when a downlink signal is sent from the base station 12-1, the antenna control device 11 distributes an RF signal sent from the base station 12-1 to each of the antennas ANT #1 to ANT #4 (S1).

Further, when uplink signals (operating frequency ID=“#2”) are sent from the wireless terminal devices through the antennas ANT #5 to ANT #8, the antenna control device 11 synthesizes RF signals input from the antennas ANT #5 and ANT #8, and transmits the synthesized signal to the base station 12-2. Further, when a downlink signal is sent from the base station 12-2, the antenna control device 11 distributes an RF signal sent from the base station 12-2 to each of the antennas ANT #5 to ANT #8 (S2).

In parallel with this, the base station 12-1 and the base station 12-2 perform data communication using an Ethernet (registered trademark) signal Eth sent via the network communication unit 31 and the local network 13 (S3 and S4).

### Radio Wave Information Measuring Mode

At the time of measuring the radio wave information (the radio wave information measuring mode), the management control device 14 performs the radio wave information measurement sequentially to each of the base stations 12-1 to 12-n (S5-1 to S5-n).

In the following, the description will be made about the radio wave information measurement in which the base station 12-1 is given as an example.

First, the management control device 14 sends a radio wave information measuring command to the base station 12-1 (S51).

Upon receipt of the radio wave information measuring command, the base station 12-1 causes the mode control unit 34 to operate the sniffing unit 33 so as to measure reception power of the downlink signals sent from outdoor base stations 61 and 62 (S52).

In addition, the management control device 14 sends the radio wave information measuring command to the antenna control device 11 (S53).

At this time, the management control device 14 puts an antenna ID (herein, antenna ID=“#1” corresponding to the antenna ANT #1) for specifying a measurement target antenna in the radio wave information measuring command, and sends the command to the antenna control device 11.

Then, the antenna control device 11, which receives the radio wave information measuring command including antenna ID=“#1” corresponding to the antenna ANT #1, switches the switch 21 to connect only the antenna ANT #1 to the base station 12-1 (S54).

Thereafter, the base station 12-1 receives the downlink signals sent from the outdoor base stations 61 and 62 through the antenna ANT #1 via the antenna control device 11 (S55 and S56), and measures the reception power (S57).

When the measurement of the reception power is completed, the base station 12-1 sends the measured reception power to the management control device 14 as a notification of radio wave measurement information corresponding to the antenna ANT #1 (S58).

The management control device 14, which receives the notification of the radio wave measurement information, writes the measurement results in the radio wave information unit 47 (S59). By repeating this operation for each of the antennas ANT #1 to ANT #n (S5-1 to S5-n), the management control device 14 can perform the measurement on each antenna to obtain the reception power of the respective downlink signals sent from the outdoor base stations 61 and 62.

### Antenna Switching Operation (Antenna Reception Frequency Assignment)

At the time of the antenna switching operation, the management control device 14 performs a process of assigning an antenna reception frequency in which an operating frequency to be assigned to each antenna is determined based on the measurement result of the radio wave information (S11).

Thereafter, the management control device 14 sends an antenna assignment request to the antenna control device 11 (S12).

The antenna switching control unit 22 of the antenna control device 11 which receives the antenna assignment request controls the switch 21 such that the antenna assignment is reflected (S13). Then, the antenna control device 11 returns an acknowledgement of the completion of the antenna assignment to the management control device 14 (S14), and ends the antenna switching operation.

### Normal Operation Mode After Switching

After the antenna switching operation, the antenna control device 11 transmits RF signals between the antennas ANT #1 to ANT #8 and the base stations 12-1 and 12-2 according to the antenna assignment described above.

Specifically, the antenna control device 11 refers to the radio wave information unit 47 illustrated in FIG. 5; for example, in the case of the antenna ANT #1, the reception power corresponding to the first operating frequency band (operating frequency ID=“#1”) is −110 dBm, and the reception power corresponding to the second operating frequency band (operating frequency ID=“#2”) is −90 dBm. Therefore, the antenna control device 11 is connected to the base station 12-1 which operates in the first operating frequency band (operating frequency ID=“#1”) having less influence as an operating frequency with reference to the operating frequency information unit 46.

Further, in the case of the antenna ANT #2, the reception power corresponding to the first operating frequency band (operating frequency ID=“#1”) is −100 dBm, and the reception power corresponding to the second operating frequency band (operating frequency ID=“#2”) is −110 dBm. Therefore, the antenna control device 11 is connected to the base station 12-2 which operates in the second operating frequency band (operating frequency ID=“#2”) having less influence as an operating frequency with reference to the operating frequency information unit 46.

Similarly, in the case of the antenna ANT #8, the reception power corresponding to the first operating frequency band (operating frequency ID=“#1”) is −90 dBm, and the reception power corresponding to the second operating frequency band (operating frequency ID=“#2”) is −70 dBm. Therefore, the antenna control device 11 is connected to the base station 12-1 which operates in the first operating frequency band (operating frequency ID=“#1”) having less influence as an operating frequency with reference to the operating frequency information unit 46.

In the normal operation after switching, as illustrated in FIG. 7, when the uplink signals (operating frequency ID=“#1”) are sent from the wireless terminal devices through the antennas ANT #1, and ANT #6 to ANT #8, the antenna control device 11 synthesizes RF signals input from the antennas ANT #1, and ANT #6 to ANT #8 based on the antenna assignment based on the measurement of the radio wave information, and transmits the synthesized signal to the base station 12-1.

Further, when a downlink signal is sent from the base station 12-1, the antenna control device 11 distributes an RF signal sent from the base station 12-1 to each of the antennas ANT #1, and ANT #6 to ANT #8 (S21).

Further, when the uplink signals (operating frequency ID=“#2”) are sent from the wireless terminal devices through the antennas ANT #2 to ANT #5, the antenna control device 11 synthesizes RF signals input from the antennas ANT #2 to ANT #5, and transmits the synthesized signal to the base station 12-2.

Further, when a downlink signal is sent from the base station 12-2, the antenna control device 11 distributes an RF signal sent from the base station 12-2 to each of the antennas ANT #2 to ANT #5 (S22).

In parallel with this, the base station 12-1 and the base station 12-2 perform data communication using an Ethernet (registered trademark) signal Eth sent via the network communication unit 31 and the local network 13 (S23 and S24).

As described above, according to the first embodiment, the connections between the antennas ANT#1 to ANT #8 and the base stations 12-1 and 12-2 can be easily switched in order to further lessen the inter-cell interference caused by the outdoor base stations 61 and 62 with respect to the individual antennas ANT #1 to ANT #8. Therefore, the distributed antenna system can be constructed to make a communication more stably.

### Second Embodiment

The above-mentioned first embodiment has been described to employ the configuration in which the connections between the antennas and the base stations are switched in order to further reduce the inter-cell interference caused by the outdoor base stations with respect to the individual antennas. However, the interference determination result of the individual antennas is not always identical to that of the entire distributed antenna system in some cases.

Therefore, a second embodiment described herein corresponds to a case where the interference determination is carried out over the entire distributed antenna system for the assignment.

Even in the second embodiment, the distributed antenna system has the same configuration as that of the first embodiment, and thus the detailed description thereof is incorporated.

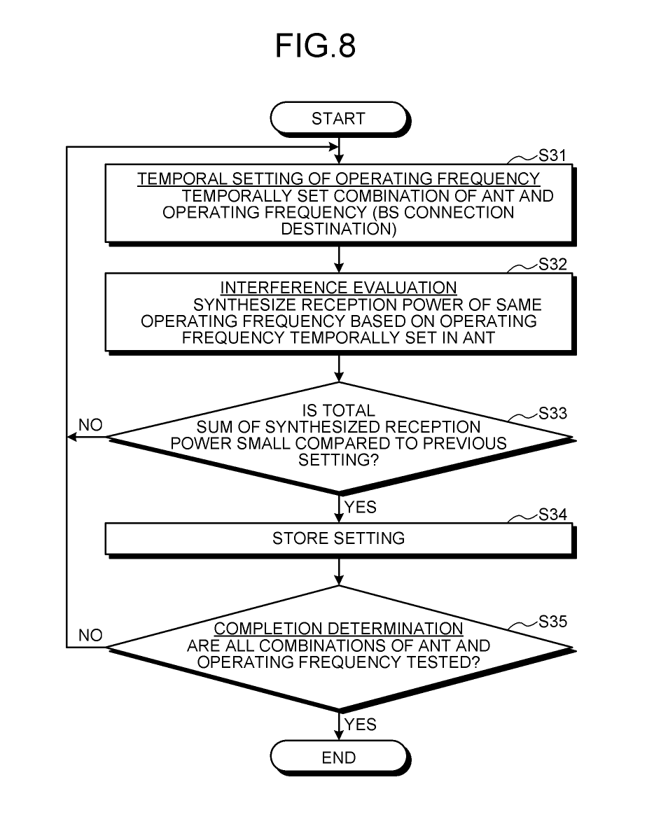

FIG. 8 is a flowchart illustrating a process in a radio wave information measuring mode according to the second embodiment.

First, the management control device 14 performs a temporal setting operation for the operating frequencies (S31).

In other words, a combination of the antennas ANT #1 to ANT #8 and a plurality of operating frequencies (the first frequency band or the second frequency band in the above-mentioned example) is temporally set.

For example, the management control device 14 assigns the operating frequencies of the antennas ANT #1 to ANT #4 to the first frequency band. Further, the management control device 14 assigns the operating frequencies of the antennas ANT #5 to ANT #8 to the second frequency band.

Subsequently, the management control device 14 measures the reception power of the respective downlink signals sent through the antennas ANT #1 to ANT #8, and synthesizes the reception power for the respective operating frequencies (S32).

Next, the management control device 14 determines whether the total sum obtained by synthesizing the reception power is small compared to the operating frequency set in the past (S33).

In the determination in S33, when the total sum obtained by synthesizing the reception power is large compared to the operating frequency set in the past (also including the case where the both sides are equal) (No in S33), the management control device 14 allows the process to proceed to S31 again to set another combination temporally, and then executes the subsequent steps as described above.

In the determination in S33, when the total sum obtained by synthesizing the reception power is small compared to the operating frequency set in the past (Yes in S33), the management control device 14 replaces the temporal setting with the previous setting to secure the temporal setting as the final setting (S34).

Subsequently, the management control device 14 determines whether all the combinations of the antennas ANT #1 to ANT #8 and the plurality of operating frequencies are tested (S35).

In the determination in S35, when all the combinations of the antennas ANT #1 to ANT #8 and the plurality of operating frequencies are not tested yet (No in S35), the management control device 14 allows the process to proceed to Step S31 again to set another combination temporally, and then executes the subsequent steps as described above.

In the determination in S35, when all the combinations of the antennas ANT #1 to ANT #8 and the plurality of operating frequencies are tested (Yes in S35), the management control device 14 ends the process.

As described above, according to the second embodiment, even when the interference determination result of the individual antennas is not always identical to that of the entire distributed antenna system in some cases, the assignment can be performed to further lessen the inter-cell interference. Therefore, the distributed antenna system can be constructed to make a communication more stably.

### MODIFICATION

In the descriptions of the above embodiments, the number of antennas to be connected to one base station is not restricted. However, it is also possible to configure the system such that a maximum or minimum number of connecting antennas is imposed and a combination (combination of the respective antennas and the base stations) causing less inter-cell interference is selected in that range.

The management control device according to the embodiment is provided with a controller such as a CPU, a storage device such as read only memory (ROM) and RAM, an external storage device such as an HDD and a CD driver, a display such as a displaying device, and an input device such as a keyboard and a mouse. Further, the management control device may be configured by employing a hardware configuration using a general purpose computer.

A control program which is executed by the management control device according to the embodiment may be provided in an installable or executable file format which can be recorded in a computer-readable recording medium such as a CD-ROM, a flexible disk (FD), a CD-R, and a digital versatile disk (DVD).

Further, the control program which is executed by the management control device according to the embodiment may be configured such that the program is stored in a computer connected to a network such as the Internet and downloaded via the network. Further, the control program which is executed by the management control device according to the embodiment may be configured such that the program is provided or distributed via the network such as the Internet.

Further, the control program of the management control device according to the embodiment may be configured such that the program is built in ROM or the like in advance for the provision.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A distributed antenna system comprising:
a plurality of antennas;
a plurality of base stations that wirelessly communicate with a wireless communication terminal, the base stations being assigned with a plurality of different operating frequencies, respectively;
an antenna control device that is connected to the antennas and is capable of connecting at least one of the antennas to any one of the base stations; and
a management control device that causes the one of the base stations to measure reception power at the at least one of the antennas at an operating frequency corresponding to other base station which is not managed by the management control device, and assigns an operating frequency having a less inter-cell interference caused by the other base station to the at least one of the antennas based on the measured reception power.

2. The distributed antenna system according to claim 1, wherein the management control device assigns, to the at least one of the antennas, one of the operating frequencies with the lowest reception power.

3. The distributed antenna system according to claim 1, wherein the management control device assigns the operating frequencies to the antennas, respectively, to further lower synthesized reception power of all of the antennas.

4. The distributed antenna system according to claim 1, wherein
each of the base stations includes a radio wave information communication unit that sends radio wave information including information of the measured reception power to the management control device, and
the management control device includes:
a radio wave information unit that stores the received radio wave information; and
an interference evaluation unit that evaluates, with reference to the radio wave information unit, the inter-cell interference caused by the other base station.

5. The distributed antenna system according to claim 1, wherein the base stations measure reception power of a downlink signal sent from the other base station which is not managed by the management control device.

6. A management control device of a distributed antenna system including a plurality of antennas, a plurality of base stations, and an antenna control device, the base stations being wirelessly communicate with a wireless communication terminal, the base stations being assigned with a plurality of different operating frequencies, respectively, the antenna control device being connected to the antennas and being capable of connecting at least one of the antennas to any one of the base stations, the management control device comprising:
a management unit that causes the one of the base stations to measure reception power at the at least one of the antennas at an operating frequency corresponding to other base station which is not managed by the management control device; and
a control unit that controls the antenna control device so as to assign an operating frequency having a less inter-cell interference caused by the other base station to the at least one of the antennas based on the measured reception power.

7. A control method of a management control device of a distributed antenna system including a plurality of antennas, a plurality of base stations, and an antenna control device, the base stations being wirelessly communicate with a wireless communication terminal, the base stations being assigned with a plurality of different operating frequencies, respectively, the antenna control device being connected to the antennas and being capable of connecting at least one of the antennas to any one of the base stations, the control method comprising:
causing the one of the base stations to measure reception power at the at least one of the antennas at an operating frequency corresponding to other base station which is not managed by the management control device; and
a control unit that controls the antenna control device so as to assign an operating frequency having a less inter-cell interference caused by the other base station to the at least one of the antennas based on the measured reception power.

8. A computer program product having a non-transitory computer readable medium including programmed instructions for controlling a distributed antenna system including a plurality of antennas, a plurality of base stations, and an antenna control device, the base stations being wirelessly communicate with a wireless communication terminal, the base stations being assigned with a plurality of different operating frequencies, respectively, the antenna control device being connected to the antennas and being capable of connecting at least one of the antennas to any one of the base stations, wherein the instructions, when executed by a computer, cause the computer to perform:
causing the one of the base stations to measure reception power at the at least one of the antennas at an operating frequency corresponding to other base station which is not managed by the management control device; and
a control unit that controls the antenna control device so as to assign an operating frequency having a less inter-cell interference caused by the other base station to the at least one of the antennas based on the measured reception power.
